(19) United States
(12) Patent Application Publication
(10) Pub. No.: US 2004/0058847 A1
(43) Pub. Date: Mar. 25, 2004

(54) Liquid washing and cleaning compositions containing consistency-imparting polymers

(75) Inventors: Roman Morschhauser, Mainz (DE); Matthias Loffler, Niedernhausen (DE); Christoph Kayser, Mainz (DE); Johannes Himmrich, Eppstein (DE); Aranka Tardi, Neuberg (DE); Sebastiano Lo Vasco, Friedberg (DE); Carsten Muller, Frankfort (DE)

Correspondence Address: Clariant Corporation, Industrial Property Department, 4000 Monroe Road, Charlotte, NC, 28205, US

(73) Assignee: Clariant GmbH

(21) Appl. No.: 10/666,450

(22) Filed: Sep. 19, 2003

(30) Foreign Application Priority Data
Sep. 19, 2002 (DE) 10243661.4

(51) Int. Cl. C11D 7/18

(52) U.S. Cl. 510/475; 510/480; 510/312

(57) ABSTRACT

The present invention relates to liquid washing, cleaning, disinfecting bleaching compositions comprising amphiphilic copolymers which include structural units derived from

a) acryloyldimethyltauric acid in free form, partially neutralized form or completely neutralized form with monovalent or divalent inorganic or organic cations, and

b) at least one hydrophobic comonomer based on ethylenically unsaturated polyalkylene alkoxylates, and optionally

c) further at least monovinylically unsaturated comonomers different from a) and b).

The present invention relates to liquid washing, cleaning, disinfecting and bleaching compositions comprising hydrophobically modified copolymers based on acryloyldimethyltauric acid. The finished formulations are characterized by favorable Theological behavior, and by good compatibility with other components. They have high storage stability, in particular high stability of hydrolysis-sensitive components, for example oxidizing agents, in the formulations, preferably in acidic formulations, and are UV stable.

Modern liquid washing, cleaning and disinfecting compositions have to meet high requirements which are closely related to the rheology of the products: as well as having a good and rapid cleaning ability toward soiling and grease, or disinfecting ability, they must be easy to use, safe, very well tolerated by the skin, but also environmentally compatible. To improve handling for the consumer and to improve the appearance, liquid products with relatively high viscosities are increasingly coming onto the market, meaning that thickeners and gel formers play a major role.

The consistency-imparting agents used hitherto have been almost exclusively synthetic or partially synthetic polymers based on crosslinked polyacrylic acids (carbomers, carbopols), partially hydrolyzed polyacrylamides, cellulose ethers, xanthan or guar gum. In this connection, the problem of intolerance toward low pH values always arises, which limits the potential applications of many technologies to the neutral range or weakly acidic range.

Accordingly, it was an object of the present invention to find a thickener for washing and cleaning composition formulations which does not lose its effectiveness even in the acidic medium below pH 5.

Surprisingly, it has now been found that this serious disadvantage can be overcome through the use of hydrophobically modified copolymers based on acryloyldimethyltaurate, the preparation of which is described in EP-A-1 069 142.

Using these polymeric structures, it has been possible to adjust formulations for washing, cleaning and disinfecting to viscosities greater than 100 cP. In particular embodiments, the formulations have acidic character (pH<5). In addition, due to the acidic medium, it is possible to permanently stabilize pH-sensitive oxidizing agents, such as, for example, hydrogen peroxide, thereby opening up new applications in the cleaning and hygiene sector. Happily, these formulations are additionally characterized by high UV stability. This permits the use of transparent packaging materials, which are currently in great demand on the market.

The invention provides liquid washing, cleaning, disinfecting and bleaching compositions comprising amphiphilic copolymers which include structural units derived from

a) acryloyldimethyltauric acid in free form, partially neutralized form or completely neutralized form with monovalent or divalent inorganic or organic cations, and

b) at least one hydrophobic comonomer based on ethylenically unsaturated polyalkylene alkoxylates, and optionally

c) further at least monovinylically unsaturated comonomers different from a) and b).

Comonomers with more than one unit capable of polymerization lead to the crosslinking of the structures according to the invention.

The copolymers according to the invention preferably have a molecular weight M_{w} of from 10³ g/mol to 10⁹ g/mol, particularly preferably from 10⁴ to 10⁷ g/mol, especially preferably 5 10⁴ to 5 10⁶ g/mol. For the purposes of this invention, M_{w} is generally determined by GPC against polystyrenesulfonic acid.

The acryloyidimethyltaurates (structural unit a) may be the inorganic or organic salts of acryloyldimethyltauric acid. Preference is given to the Li⁺, Na⁺, K⁺, Mg⁺⁺, Ca⁺⁺, Al⁺⁺⁺ and/or NH₄⁺ salts. Preference is likewise given to the monoalkylammonium salts, dialkylammonium salts, trialkylammonium salts and/or tetraalkylammonium salts, where the alkyl substituents of the amines may, independently of one another, be (C₁-C₂₂)-alkyl radicals, which may optionally be occupied by up to 3 (C₂-C₁₀)-hydroxyalkyl groups. In addition, preference is also given to mono-to triethoxylated ammonium compounds with a varying degree of ethoxylation. It should be noted that mixtures of two or more of the abovementioned compounds are also in accordance with the invention.

The degree of neutralization of the acryloyldimethyltauric acid can be between 0 and 100%, particular preference being given to a degree of neutralization of more than 80%.

Based on the total mass of the copolymers, the content of acryloyldimethyltauric acid and acryloyidimethyltaurates can be 0.1 to 99.9% by weight, preferably 20 to 99.5% by weight, particularly preferably 50 to 98% by weight.

According to the invention, at least one so-called macromonomer (structural unit b) is used in the copolymerization. The macromonomers are at least monoolefinically functionalized polymers with one or more discrete repeat units and a number-average molecular weight greater than or equal to 200 g/mol. It is also possible to use mixtures of chemically different macromonomers b) in the copolymerization.

Based on the total mass of the copolymers, the content of macromonomers (structural unit b) can preferably be 0.1 to 99.9% by weight, in particular 0.5 to 80% by weight, particularly preferably 2 to 50% by weight.

Preferred macromonomers b) are compounds according to formula (I).

R¹—Y-[(A)ᵥ-(B)_{w}—(C)ₓ-(D)_{z}]-R² (I)

R¹ is a function capable of polymerization from the group of vinylically unsaturated compounds which are suitable for building up polymeric structures in a free-radical manner. R¹ is preferably a vinyl, allyl, methallyl, methylvinyl, acrylic, methacrylic, crotonyl, senecionyl, itaconyl, maleinyl, fumaryl or styryl radical.

The joining of the polymer chain to the reactive end group requires a suitable bridging group Y. Preferred bridges Y are —O—, —C(O)—, —C(O)—O—, —S—, —O—CH₂—CH(O—)—CH₂OH, —O—CH₂—CH(OH)—CH₂O—, —O—SO₂—O—, —O—SO—O—, —PH—, —P(CH₃)—, —PO₃—, —NH—and —N(CH₃)—, particularly preferably —O—.

The polymeric middle section of the macromonomer is represented by the discrete repeat units A, B, C and D. Preferred repeat units A, B, C and D are derived from acrylamide, methacrylamide, ethylene oxide, propylene oxide, AMPS, acrylic acid, methacrylic acid, methyl methacrylate, acrylonitrile, maleic acid, vinyl acetate, styrene, 1,3-butadiene, isoprene, isobutene, diethylacrylamide and diisopropylacrylamide, in particular from ethylene oxide and propylene oxide.

The indices v, w, x and z in formula (I) represent the stoichiometric coefficients relating to the repeat units A, B, C and D. v, w, x and z are, independently of one another, 0 to 500, preferably 1 to 30, where the sum of the four coefficients must on average be ≧1.

The distribution of the repeat units over the macromonomer chain may be random, block-like, alternating or gradient-like.

R² is a linear or branched, aliphatic, olefinic, cycloaliphatic, arylaliphatic or aromatic (C₁-C₅₀)-hydrocarbon radical, OH, —NH₂, —N(CH₃)₂ or is the structural unit [—Y—R¹]. Where R² is [—Y—R¹], the macromonomers are difunctional and are suitable for crosslinking the copolymers.

Particularly preferred macromonomers b) are acrylically or methacrylically monofunctionalized alkyl ethoxylates according to formula (II).

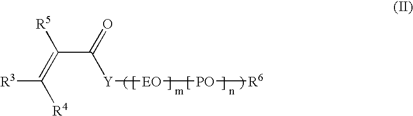

R₃, R₄, R₅ and R₆ are, independently of one another, hydrogen or n-aliphatic, isoaliphatic, olefinic, cycloaliphatic, arylaliphatic or aromatic (C₁-C₃₀)-hydrocarbon radicals.

Preferably, R₃ and R₄ are H or —CH₃, particularly preferably H. R₅ is H or —CH₃, and R₆ is an n-aliphatic, isoaliphatic, olefinic, cycloaliphatic, arylaliphatic or aromatic (C₁-C₃₀)-hydrocarbon radical.

m and n are in turn the stoichiometric coefficients relating to the ethylene oxide units (EO) and propylene oxide units (PO). m and n are, independently of one another, 0 to 500, preferably 1 to 30, where the sum of m and n must on average be ≧1. The distribution of the EO and PO units over the macromonomer chain may be random, block-like, alternating or gradient-like. Y is the abovementioned bridges.

Particularly preferred macromonomers have the following structure according to formula (II):

| Name | R³ | R⁴ | R⁵ | R⁶ | m | n |
|---|---|---|---|---|---|---|
| ® LA-030 methacrylate | H | H | —CH₃ | -lauryl | 3 | 0 |
| LA-070 methacrylate | H | H | —CH₃ | -lauryl | 7 | 0 |
| LA-200 methacrylate | H | H | —CH₃ | -lauryl | 20 | 0 |
| LA-250 methacrylate | H | H | —CH₃ | -lauryl | 25 | 0 |
| T-080 methacrylate | H | H | —CH₃ | -tallow | 8 | 0 |
| T-080 acrylate | H | H | H | -tallow | 8 | 0 |
| T-250 methacrylate | H | H | —CH₃ | -tallow | 25 | 0 |
| T-250 crotonate | —CH₃ | H | —CH₃ | -tallow | 25 | 0 |
| OC-030 methacrylate | H | H | —CH₃ | -octyl | 3 | 0 |
| OC-105 methacrylate | H | H | —CH₃ | -octyl | 10 | 5 |
| Behenyl-010 metharyl | H | H | H | - | 10 | 0 |
| | | | | behenyl | | |
| Behenyl-020 metharyl | H | H | H | - | 20 | 0 |
| | | | | behenyl | | |
| Behenyl-010 | —CH₃ | —CH₃ | H | - | 10 | 0 |
| senecionyl | | | | behenyl | | |
| PEG-440 diacrylate | H | H | H | -acryl | 10 | 0 |
| B-11-50 methacrylate | H | H | —CH₃ | -butyl | 17 | 13 |
| MPEG-750 | H | H | —CH₃ | -methyl | 18 | 0 |
| methacrylate | | | | | | |
| P-010 acrylate | H | H | H | -phenyl | 10 | 0 |
| O-050 acrylate | H | H | H | -oleyl | 5 | 0 |

Preferably, the molecular weight of the macromonomers b) is 200 g/mol to 10⁶ g/mol, particularly preferably 150 to 10⁴ g/mol and especially preferably 200 to 5000 g/mol.

Comonomers c) which can be used are all olefinically unsaturated monomers whose reaction parameters permit copolymerization with acryloyldimethyltauric acid and/or acryloyldimethyltaurates in the respective reaction media.

Preference is given to using open-chain N-vinylamides, preferably N-vinylformamide (VIFA), N-vinylmethylformamide, N-vinylmethylacetamide (VIMA) and N-vinylacetamide; cyclic N-vinylamides (N-vinyllactams) with a ring size of from 3 to 9, preferably N-vinylpyrrolidone (NVP) and N-vinylcaprolactam; amides of acrylic acid and methacrylic acid, preferably acrylamide, methacrylamide, N,N-dimethylacrylamide, N,N-diethylacrylamide and N,N-diisopropylacrylamide; alkoxylated acrylamides and methacrylamides, preferably hydroxyethyl methacrylate, hydroxymethylmethacrylamide, hydroxyethylmethacrylamide, hydroxypropylmethacrylamide and succinic mono-[2-(methacryloyloxy)ethyl ester]; N,N-dimethylaminomethacrylate; diethylaminomethyl methacrylate; acryl- and methacrylamidoglycolic acid; 2- and 4-vinylpyridine; vinyl acetate; glycidyl methacrylate; styrene; acrylonitrile; stearyl acrylate; lauryl methacrylate.

Additionally, one or more unsaturated carboxylic acids or salts thereof may be copolymerized into the structure. In particular, preference is given to acrylic acid, methacrylic acid, styrenesulfonic acid, maleic acid, fumaric acid, crotonic acid, itaconic acid and senecioic acid.

Preferred counterions of the acids are Li⁺, Na⁺, K⁺, Mg⁺⁺, Ca⁺⁺, Al⁺⁺⁺, NH₄⁺, monoalkylammonium, dialkylammonium, trialkylammonium and/or tetraalkylammonium radicals, where the alkyl substituents of the amines may, independently of one another, be (C₁-C₂₂)-alkyl radicals, which may optionally be occupied by up to 3 (C₂-C₁₀)-hydroxyalkyl groups. Additionally, mono- to triethoxylated ammonium compounds with varying degree of ethoxylation can also be used. The degree of neutralization of the carboxylic acids can be between 0 and 100%.

In a further embodiment, the copolymers according to the invention are crosslinked, i.e. they contain comonomers (structural unit c) with at least two vinyl groups capable of polymerization.

Preferred crosslinkers are methylenebisacrylamide; methylenebismethacrylamide; esters of unsaturated mono- and polycarboxylic acids with polyols, preferably diacrylates and triacrylates or -methacrylates, particularly preferably butanediol and ethylene glycol diacrylate or -methacrylate, trimethylolpropane triacrylate (TMPTA) and allyl compounds, preferably allyl (meth)acrylate, triallyl cyanurate, diallyl maleate, polyallyl ester, tetraallyloxyethane, triallylamine, tetraallylethylenediamine; allyl esters of phosphoric acid; and/or vinylphosphonic acid derivatives.

A particularly preferred crosslinker is trimethylolpropane triacrylate (TMPTA) and trimethylolpropane trimethacrylate (TMPTMA).

Mixtures of vinylically monounsaturated comonomers with polyunsaturated comonomers (crosslinkers) are likewise in accordance with the invention.

The proportion by weight of the comonomers (structural unit c), based on the total mass of the copolymers according to the invention is preferably 0.01 to 90% by weight, particularly preferably 0.05 to 50% by weight and especially preferably 0.1 to 40% by weight.

As polymerization medium, it is possible to use all organic or inorganic solvents which behave largely inertly with regard to free-radical polymerization reactions and advantageously permit the formation of moderate or high molecular weights. Preference is given to using water, lower alcohols, preferably methanol, ethanol, propanols, isobutanol, sec-butanol and t-butanol, especially preferably t-butanol, hydrocarbons having 1 to 30 carbon atoms and mixtures of the abovementioned compounds.

The polymerization reaction preferably takes place in the temperature range between 0 and 150° C., particularly preferably between 10 and 100° C., either at atmospheric pressure or under increased or reduced pressure. In some instances, the polymerization can also be carried out under a protective-gas atmosphere, preferably under nitrogen.

The polymerization can be triggered using high-energy electromagnetic rays, mechanical energy or the customary chemical polymerization initiators, such as organic peroxides, e.g. benzoyl peroxide, tert-butyl hydroperoxide, methyl ethyl ketone peroxide, cumene hydroperoxide, dilauroyl peroxide (DLP) or azo initiators, such as, for example, azodiisobutyronitrile (AIBN).

Likewise suitable are inorganic peroxy compounds, such as, for example, (NH₄)₂S₂O₈, K₂S₂O₈ or H₂O₂, optionally in combination with reducing agents (e.g. sodium hydrogensulfite, ascorbic acid, iron(II) sulfate etc.) or redox systems which comprise an aliphatic or aromatic sulfonic acid (e.g. benzenesulfonic acid, toluenesulfonic acid etc.) as reducing component.

The polymerization reaction can be carried out, for example, as a precipitation polymerization, emulsion polymerization, bulk polymerization, solution polymerization or gel polymerization. For the profile of properties of the copolymers according to the invention, suspension polymerization is particularly advantageous, preferably in tert-butanol.

According to the invention, the above-described hydrophobically modified copolymers based on acryloyidimethyltaurate can generally be used in all washing, cleaning, disinfecting and bleaching compositions of every type. They are preferably used as thickeners in acidic cleaning composition formulations for hard surfaces made of ceramic, metal, glass or plastic, for example in liquid all-purpose cleaners, in the sanitary sector, for example liquid toilet block, lime-dissolving bath cleaner, but also dishwashing detergents. Furthermore, they are suitable for use in stain-removal salt compositions, liquid detergents and laundry bleaches.

The washing, cleaning, disinfecting and bleaching compositions according to the invention can be in the form of aqueous, aqueous/organic, in particular aqueous/alcoholic and organic formulations. Further embodiments may be: emulsions, dispersions, gels and suspensions.

In a preferred embodiment, the washing, cleaning, disinfecting and bleaching compositions according to the invention comprise an acidic component.

Suitable are organic or inorganic acids, preferably organic acids, especially preferably alpha-hydroxy acids and acids chosen from glycolic acid, lactic acid, citric acid, tartaric acid, mandelic acid, salicylic acid, ascorbic acid, pyruvic acid, oligooxamono- and dicarboxylic acids, fumaric acid, retinoic acid, aliphatic and organic sulfonic acids, benzoic acid, kojic acid, fruit acid, malic acid, gluconic acid, galacturonic acid, acidic plant and/or fruit extracts and derivatives thereof.

Furthermore, preferred embodiments may comprise oxidizing agents, in particular hydrogen peroxide or addition compounds thereof, for example the addition compounds of hydrogen peroxide onto urea, melamine or sodium borate, or solutions of perborate or percarbonate optionally also caroate.

The preparations according to the invention can comprise oxidizing agents in amounts of from 0.1 to 30% by weight, particularly preferably 0.5 to 18% by weight, in particular 1.5 to 9% by weight.

The washing, cleaning, disinfecting and bleaching compositions according to the invention can comprise surfactants nonionic, anionic, cationic or amphoteric in nature, and also customary auxiliaries and additives in varying amounts.

Preferred nonionic surfactants are fatty alcohol oxethylates having about 1 to about 25 mol of ethylene oxide. The alkyl chain of the aliphatic alcohols may be linear or branched, primary or secondary, and generally contains from 8 to 22 carbon atoms. Particular preference is given to the condensation products of alcohols which contain an alkyl chain from 10 to 20 carbon atoms, with 2 to 18 mol of ethylene oxide per mole of alcohol. The alkyl chain may be saturated or else unsaturated. The alcohol ethoxylates may likewise have a narrow homolog distribution of the ethylene oxide (narrow range ethoxylates) or a broad homolog distribution of the ethylene oxide (broad range ethoxylates). Examples of commercially available nonionic surfactants of this type are Tergitol™ 15-S-9 (condensation product of a C₁₁-C₁₅ linear secondary alcohol with 9 mol of ethylene oxide), Tergitol™ 24-L-NMW (condensation product of a C₁₂-C₁₄-linear primary alcohol with 6 mol of ethylene oxide with narrow molecular weight distribution). This class of product likewise comprises the Genapol™-grades from Clariant GmbH.

Moreover, other known grades of nonionic surfactants are also suitable according to the invention, such as polyethylene, polypropylene and polybutylene oxide adducts of alkylphenols having 6 to 12 carbon atoms in the alkyl chain, addition products of ethylene oxide with a hydrophobic base, formed from the condensation of propylene oxide with propylene glycol or addition products of ethylene oxide with a reaction product of propylene oxide and ethylenediamine.

In addition, semipolar nonionic surfactants, for example amine oxides of the formula III

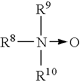

can be used, in which R⁸ is an alkyl, hydroxyalkyl or alkylphenol group or mixtures thereof with a chain length of from 8 to 22 carbon atoms; R⁹ is an alkylene or hydroxyalkylene group having 2 to 3 carbon atoms or mixtures thereof; R¹⁰ is an alkyl or hydroxyalkyl group having 1 to 3 carbon atoms or a polyethylene oxide group having 1 to 3 ethylene oxide units. The R¹⁰/R⁹ groups can be joined together via an oxygen or nitrogen atom and thus form a ring.

These amine oxides include, in particular, C₁₀-C₁₈-alkyldimethylamine oxides and C₈-C₁₂-alkoxyethyldihydroxyethylamine oxides.

Instead of or in addition to the nonionic surfactants, the mixtures according to the invention can also comprise anionic surfactants.

Suitable anionic surfactants are especially straight-chain and branched alkyl sulfates, alkylsulfonates, alkyl carboxylates, alkyl phosphates, alkyl ester sulfonates, arylalkylsulfonates, alkyl ether sulfates and mixtures of said compounds. Some of the suitable grades of anionic surfactants will be described below in more detail.

Alkyl Ester Sulfonates

Alkyl ester sulfonates are linear esters of C₈-C₂₀-carboxylic acids (i.e. fatty acids) which are sulfonated by SO₃, as described in “The Journal of the American Oil Chemists Society”, 52 (1975), pp. 323-329. Suitable starting materials are natural fatty derivatives, such as, for example, tallow or palm oil fatty acid.

Alkyl Sulfates

Alkyl sulfates are water-soluble salts or acids of the formula ROSO₃M, in which R is preferably a C₁₀-C₂₄-hydrocarbon radical, preferably an alkyl or hydroxyalkyl radical having 10 to 20 carbon atoms, particularly preferably a C₁₂-C₁₈-alkyl or hydroxyalkyl radical. M is hydrogen or a cation, e.g. an alkali metal cation (e.g. sodium, potassium, lithium) or ammonium or substituted ammonium, e.g. a methylammonium, dimethylammonium and trimethylammonium cation or a quaternary ammonium cation, such as tetramethylammonium and dimethylpiperidinium cation and quaternary ammonium cations derived from alkylamines, such as ethylamine, diethylamine, triethylamine and mixtures thereof. Alkyl chains with C₁₂-C₁₆ are preferred here for low washing temperatures (e.g. below about 50° C.) and alkyl chains with C₁₆-C₁₈ are preferred for higher washing temperatures (e.g. above about 50° C.).

Alkyl Ether Sulfates

The alkyl ether sulfates are water-soluble salts or acids of the formula RO(A)ₘSO₃M, in which R is an unsubstituted C₁₀-C₂₄-alkyl or hydroxyalkyl radical having 10 to 24 carbon atoms, preferably a C₁₂-C₂₀-alkyl or hydroxyalkyl radical, particularly preferably a C₁₂-C₁₈-alkyl or hydroxyalkyl radical. A is an ethoxy or propoxy unit, m is a number greater than 0, typically between about 0.5 and about 6, particularly preferably between about 0.5 and about 3, and M is a hydrogen atom or a cation, such as, for example, a metal cation (e.g. sodium, potassium, lithium, calcium, magnesium, etc.), ammonium or a substituted ammonium cation. Examples of substituted ammonium cations are methylammonium, dimethylammonium, trimethylammonium and quaternary ammonium cations, such as tetramethylammonium and dimethylpiperidinium cations, and also those derived from alkylamines, such as ethylamine, diethylamine, triethylamine, mixtures thereof and the like. Examples which may be mentioned are C₁₂C₁₈-alkyl polyethoxylate(1.0) sulfate, C₁₂-C₁₈-alkyl polyethoxylate(2.25) sulfate, C₁₂-C₁₈-alkyl polyethoxylate(3.0) sulfate, C₁₂-C₁₈-alkyl polyethoxylate(4.0) sulfate, where the cation is sodium or potassium.

Other anionic surfactants which are useful for use in washing and cleaning compositions are C₈-C₂₄-olefinsulfonates, sulfonated polycarboxylic acids prepared by sulfonation of the pyrolysis products of alkaline earth metal citrates, as described, for example, in British patent GB 1,082,179, alkylglycerol sulfates, fatty acylglycerol sulfates, oleylglyceryl sulfates, alkylphenol ether sulfates, primary paraffin sulfonates, alkyl phosphates, alkyl ether phosphates, isethionates, such as acyl isethionates, N-acyltaurides, alkyl succinamates, sulfosuccinates, monoesters of sulfosuccinates (particularly saturated and unsaturated C₁₂-C₁₈-monoesters) and diesters of sulfosuccinates (particularly saturated and unsaturated C₁₂-C₁₈-diesters), acyl sarcosinates, sulfates of alkylpolysaccharides, such as sulfates of alkyloyl glycosides, branched primary alkyl sulfates and alkyl polyethoxycarboxylates, such as those of the formula RO(CH₂CH₂)ₖCH₂COO⁻M⁺ in which R is a C₈-C₂₂-alkyl, k is a number from 0 to 10 and M is a cation which forms a soluble salt. Resin acids or hydrogenated resin acids, such as rosin or hydrogenated rosin or tall oil resins and tall oil resin acids can likewise be used. Further examples are described in “Surface Active Agents and Detergents” (Vol. I and II, Schwartz, Perry and Berch). A large number of such surfactants is also claimed in U.S. Pat. No. 3,929,678.

Examples of amphoteric surfactants which may be used in the formulations of the present invention are primarily those which have broadly been described as derivatives of aliphatic secondary and tertiary amines in which the aliphatic radical may be linear or branched and in which one of the aliphatic substituents contains between 8 and 18 carbon atoms and contains an anionic, water-soluble group, such as, for example, carboxy, sulfonate, sulfate, phosphate or phosphonate.

Further preferred amphoteric surfactants are alkyldimethylbetaines, alkylamidobetaines and alkyldipolyethoxybetaines with an alkyl radical which may be linear or branched, having 8 to 22 carbon atoms, preferably having 8 to 18 carbon atoms and particularly preferably having 12 to 18 carbon atoms. These compounds are marketed, for example, by Clariant GmbH under the trade name Genagen® CAB.

Auxiliaries and Additives

Depending on intended application, the washing and cleaning compositions comprise, as well as said surfactants, also the auxiliaries and additives specific in each case, for example builders, salts (electrolytes), bleaches, bleach activators, optical brighteners, complexing agents, graying inhibitors, solubility promoters, enzymes, thickeners, preservatives, fragrances and dyes, pearlizing agents, foam inhibitors, sequesterants.

Suitable organic and inorganic builders are salts which are neutral or, in particular, alkaline and which are able to precipitate out calcium ions or to bind them in complexes. Suitable and particularly ecologically acceptable builder substances, such as finely crystalline, synthetic water-containing zeolites of the type NaA which have a calcium-binding capacity in the range from 100 to 200 mg of CaO/g are preferably used. In nonaqueous systems, phyllosilicates are preferably used. Zeolite and the phyllosilicates can be present in the composition in an amount up to 20% by weight. Organic builder substances which can be used are, for example, the percarboxylic acids preferably used in the form of their sodium salts, such as citric acid and nitriloacetate (NTA), ethylenediaminetetraacetic acid, provided such a use is not precluded for ecological reasons. Analogously to this, it is also possible to use polymeric carboxylates and salts thereof. These include, for example, the salts of homopolymeric or copolymeric polyacrylates, polymethacrylates and in particular copolymers of acrylic acid with maleic acid, preferably those comprising 50% to 10% of maleic acid and also polyvinylpyrrolidone and urethanes. The relative molecular mass of the homopolymers is generally between 1000 and 100 000, that of the copolymers is between 2000 and 200 000, preferably 50 000 to 120 000, based on the free acid, particularly suitable are also water-soluble polyacrylates which are crosslinked, for example, with about 1% of a polyallylether of sucrose and which have a relative molecular mass above one million. Examples thereof are the polymers obtainable under the name Carbopol 940 and 941. The crosslinked polyacrylates are used in amounts not exceeding 1% by weight, preferably in amounts of from 0.2 to 0.7% by weight.

As electrolyte, the compositions according to the invention comprise salts. The salts are heteropolar compounds in whose crystal lattice at least one cation type different from hydrogen ions, and at least one anion type different from hydroxide ions are involved. Preferably, the compositions according to the invention comprise inorganic salts, particularly preferably ammonium or metal salts, preferably of halides, oxides, carbonates, hydrogencarbonates, phosphates, sulfates, nitrates, particularly preferably sodium chloride; and/or organic salts, preferably ammonium or metal salts, preferably of glycolic acid, lactic acid, citric acid, tartaric acid, mandelic acid, salicylic acid, ascorbic acid, pyruvic acid, fumaric acid, retinoic acid, sulfonic acids, benzoic acid, kojic acid, fruit acid, malic acid, gluconic acid, galacturonic acid.

The salts are preferably derived from mono- or polybasic acids and mono- and polyacid bases, preferably from monobasic acids and/or monoacid bases. Particular preference is given to sodium, potassium and ammonium salts.

As electrolyte, the compositions can also comprise mixtures of different salts. The compositions comprise the electrolytes usually in a concentration of from 0.01 to 50% by weight, preferably 0.1 to 50% by weight, particularly preferably 0.5 to 10% by weight.

As foam inhibitors, the compositions according to the invention can comprise fatty acid alkyl ester alkoxylates, organopolysiloxanes and mixtures thereof with microfine, optionally silanized silica, and paraffins, waxes, microcrystalline waxes and mixtures thereof with silanized silica. It is also advantageously possible to use mixtures of different foam inhibitors, e.g. those of silicone oil, paraffin oil or waxes. Preferably, foam inhibitors are bonded to a granular, water-soluble or -dispersible carrier substance.

The liquid washing compositions can comprise optical brighteners, for example derivatives of diaminostilbenedisulfonic acid or alkali metal salts thereof which can be readily incorporated into the dispersion. The maximum content of brighteners in the compositions according to the invention is 0.5% by weight, preference being given to using amounts of from 0.02 to 0.25% by weight.

The desired viscosity of the compositions can be adjusted by adding water and/or organic solvents or by adding a combination of organic solvents and further thickeners.

In principle, suitable organic solvents are all mono- or polyhydric alcohols. Preference is given to using alcohols having 1 to 4 carbon atoms, such as methanol, ethanol, propanol, isopropanol, straight-chain and branched butanol, glycerol and mixtures of said alcohols. Further preferred alcohols are polyethylene glycols with a relative molecular mass below 2000. Particular preference is given to using polyethylene glycol with a relative molecular mass between 200 and 600 and in amounts up to 45% by weight, and of polyethylene glycol with a relative molecular mass between 400 and 600 in amounts of from 5 to 25% by weight. An advantageous mixture of solvents consists of monomeric alcohol, for example ethanol and polyethylene glycol in the ratio 0.5:1 to 1.2:1, where the liquid washing compositions according to the invention can comprise 8 to 12% by weight of such a mixture.

Further suitable solvents are, for example, triacetin (glycerol triacetate) and 1-methoxy-2-propanol.

The thickeners used are preferably hydrogenated castor oil, salts of long-chain fatty acids, preferably in amounts of from 0 to 5% by weight and in particular in amounts of from 0.5 to 2% by weight, for example sodium, potassium, aluminum, magnesium and titanium stearates or the sodium and/or potassium salts of behenic acid, and also polysaccharides, in particular xanthan gum, guar guar, agar agar, alginates and tyloses, carboxymethylcellulose and hydroxyethylcellulose, and also relatively high molecular weight polyethylene glycol mono- and diesters of fatty acids, polyacrylates, polyvinyl alcohol and polyvinylpyrrolidone.

Suitable enzymes are those from the class of proteases, lipases, amylases and mixtures thereof. Their proportion may be 0.2 to 1% by weight. The enzymes can be adsorbed to carrier substances and/or embedded in coating substances.

In order to bind traces of heavy metals, the salts of polyphosphoric acids, such as 1-hydroxyethane-1,1-diphosphonic acid (HEDP) and diethylenetriaminepentamethylenephosphonic acid (DTPMP), preferably in weight amounts of from 0.1 to 1.0% by weight, can be used.

Suitable preservatives are, for example, phenoxyethanol, formaldehyde solution, parabens, pentanediol or sorbic acid.

Suitable pearlizing agents are, for example, glycol distearic esters, such as ethylene glycol distearate, but also fatty acid monoglycol esters.

Suitable salts or extenders are, for example, sodium sulfate, sodium carbonate and sodium silicate (waterglass).

Typical individual examples of further additives are sodium borate, starch, sucrose, polydextrose, stilbene compounds, methylcellulose, toluenesulfonate, cumenesulfonate, soaps and silicones.

The compositions according to the invention are usually adjusted to a pH in the range 2 to 12, preferably pH 2.1 to 7.8, particularly preferably 2.2 to 6.5.

By using hydrophobically modified copolymers containing acryloyldimethyltaurate, it was possible to thicken formulations with a pH of <5 to viscosities above 100 mPas. These formulations firstly have the advantage that the viscosification prevents “splashing” of the cleaning composition and thereby ensures safer use. In addition, the increased viscosity provides for slower run-off of the cleaning composition from the surfaces and thus guarantees a longer contact time. As a result of the broad pH tolerance of the polymers used, it is possible for the first time to use relatively strong organic acids, such as, for example, citric acid, malic acid, alpha-hydroxycarboxylic acids and oxalic acid, in free form. Improved effectiveness, specifically toward limescale deposits, can thus be achieved.

In said formulations, hydrophobically modified copolymers containing acryloyldimethyltaurate are used in an amount of from 0.01 to 10% by weight. Preference is given to working with an amount of from 0.1 to 5% by weight. Particular preference is given to the range from 0.2 to 2% by weight. Depending on the amount of polymer used, the viscosity of the resulting gels can be between 100 and 100 000 mPas.

Liquid Cleaning Gels Comprising Water/Organic Solvent Mixtures

The thickening of organic solvents, specifically alcohols, in combination with anionic and nonionic surfactants and other formulation constituents is readily possible through the use of hydrophobically modified copolymers containing acryloyidimethyltaurate. To qualify this, it should be noted that only water-compatible organic solvents are within the meaning of the invention. Nonlimiting examples which may be mentioned are ethanol, propanol, isopropanol, DMSO, NMP, acetone, methanol and butanol. The resulting gels can comprise between 0.1 and 90% by weight of organic solvent fraction. Preference is given to a fraction of from 5 to 80% by weight. Particular preference is given to gels with a content of organic solvents of from 20 to 60% by weight. In general, hydrophobically modified copolymers containing acryloyldimethyltaurate are used in these formulations in an amount of from 0.01 to 10% by weight. Preference is given to working with an amount of from 0.1 to 5% by weight. Particular preference is given to the range from 0.2 to 2% by weight.

Here, the viscosities of the resulting cleaning gels comprising organic solvents can vary between 100 and 100 000 mPas, depending on the amount of polymer used.

A field of use which may be mentioned here is also the cleaning of grease-encrusted hard surfaces, such as tiles, glass or ceramic or metal. Possible fields of use according to the invention are, for example, bath cleaners, glass cleaners, and floor cleaners.

Liquid Cleaning Gels Comprising Disinfectants

Disinfectant gels play a large role in the hygiene sector and have been enjoying increased popularity in the market place for a number of years. Specifically, gels used as “liquid toilet blocks” have been gaining ground for years in the sanitary sector.

The thickening of aqueous disinfectant solutions by conventional thickeners based on cellulose ethers or polyacrylic acids sometimes requires a high use concentration of these polymers and is additionally limited to the neutral to weakly acidic pH range.

The use of hydrophobically modified copolymers containing acryloyidimethyltaurate can overcome this limitation. It is possible for the first time to combine liquid cleaning gels containing disinfectants with acidic formulation constituents such as fruit acid or alpha-hydroxycarboxylic acids and thus to also achieve a “limescale-dissolving” effect as well as the antiseptic effect.

Hydrophobically modified copolymers containing acryloyidimethyltaurate are used in said formulations in an amount of from 0.01 to 10% by weight. Preference is given to working with an amount of from 0.1 to 5% by weight. Particular preference is given to the range from 0.2 to 2% by weight. Depending on the amount of polymer used, the viscosity of the resulting gels can be between 100 and 100 000 mPas.

Thickening of acidic solutions containing peroxide with hydrophobically modified acryloyidimethyltaurate polymers.

For liquid formulations of peroxide solutions, it is desirable to thicken these. This makes handling simpler and safer. Formulations according to the invention can comprise organic or inorganic peroxides, in particular hydrogen peroxide or a mixture of these. For various applications, it is desirable for the peroxide solutions to adhere to the substrate and not run off so that the effect can develop completely. However, solutions of peroxide with conventional thickeners can only be thickened or stabilized with difficulty over a prolonged period. The reason for this is that a hydrogen peroxide solution is comparatively unstable even at neutral or only weakly acidic pH values. During the decomposition, the thickeners are also attacked and the viscosity is greatly reduced over time. This additionally results in a considerable loss in hydrogen peroxide activity. At an acidic pH, the decomposition of hydrogen peroxide is greatly retarded, but the thickening ability of thickeners based on acrylic acid breaks down at pH values of <5.5.

The use of hydrophobically modified acryloyldimethyltaurate polymers according to the invention in bleach solutions thickens the formulation also at pH values significantly below the threshold value of pH 5. The thickening ability of the polymers according to the invention remains virtually constant in a pH value range from 1.5 to 9. Even formulations with pH values around pH 2 are therefore accessible with the thickeners according to the invention. In this pH range, no noticeable decomposition of H₂O₂ takes place over normal storage periods, meaning that the hydrophobically modified acryloyldimethyltaurate polymers according to the invention are not attacked and destroyed and thus the viscosity of the formulation according to the invention remains virtually constant.

To illustrate the invention, a number of nonlimiting potential uses of such acidic thickened hydrogen peroxide solutions is listed below:

Bleaching solutions e.g. for the cleaning of laundry (liquid stain-removal salt) or dishes:

A solution of 0.1 to 30% ww H₂O₂, preferably from 1 to 15% ww, particularly preferably from 3 to 10% ww, can be thickened by means of hydrophobically modified acryloyidimethyltaurate polymers according to the invention at pH values of <5. Even at elevated storage temperatures, a viscosity stable for months is found. The thickening of the bleaching solution makes it easier for the user to establish the optimum dosing. The solution does not splash and handling is therefore safer.

Peroxide-containing cleaners can be used, for example, in the field of hard-surface cleaning in the hygiene or sanitary sector. In this case, formulations can be prepared which also comprise anionic and nonionic surfactants. Those compositions for, for example, the cleaning of toilets, are very useful. The peroxide-containing cleaner adheres to the ceramic and can thus develop its optimum cleaning and disinfecting action.

Gel or liquid filled long-term cleaners (liquid toilet blocks) for hanging in the cistern or the WC bowl can be realized with a similar formulation. Some of the gel-like thickened solution is distributed during each flushing operation with the stream of water in the bowl and thus provides a cleaning and disinfecting action. Using the hydrophobically modified acryloyldimethyltaurate polymers according to the invention, clear formulations are accessible which correspond to the current trend for clear formulations and transparent packagings.

The examples and applications below serve to illustrate the invention in more detail without, however, limiting it thereto (all percentages given are percentage by weight).

Polymer A is poly[acryloyldimethyltauric acid ammonium salt-co-Genapol-T-250 methacrylate-co-trimethylolpropane trimethacrylate], Mw 570 000 g/mol.

Polymer B is poly[acryloyldimethyltauric acid sodium salt-co-Genapol-070 acrylate], Mw 1 000 000 g/mol.

Polymer C is poly[acryloyldimethyltauric acid ammonium salt-co-vinylformamide-co-MPEG 750 methacrylate-co-trimethylolpropane triacrylate], Mw 1 500 000 g/mol.

Liquid cleaning gels with pH <5 for hard surfaces.

All formulations additionally comprise, as required, preservatives, dye and/or perfume.

Formulation for liquid bleach booster (liquid stain-removal salts)

| 1.5% | Linear alkylbenzenesulfonate |
|---|---|
| 2.5% | Genapol OA 070 |
| 6.6% | H₂O₂ |
| 0.2% | Phosphonate |
| 88.7% | Water |
| 0.5% | Polymer A |
| pH (1 g/l) | 4.3 |
| 2.2% | Lauryl sulfate |
| 4.5% | Genapol OA 070 |
| 7.0% | H₂O₂ |
| 0.5% | Phosphonate |
| 85.3% | Water |
| 0.5% | Polymer B |
| pH (1 g/l) | 4.8 |
| Viscosity | 300 mPas |

Typical viscosities of high-concentration formulations are in the range from 700-1000 mPas, typical viscosities of gels are in the range from 2000-3000 mPas.

Liquid bleach boosters are dosed into the washing machine in addition to the washing composition in order to improve stain removal. They can also be applied directly onto the stain on the fabric for pretreatment. The higher viscosity gives the impression of higher activity. When applied directly, more targeted application can also be made possible.

Formulation for hard surface cleaner gel containing bleach

| 6.7% | Genapol UD 080 |
|---|---|
| 0.4% | Soap |
| 0.8% | Soda |
| 6.2% | H₂O₂ |
| 0.3% | Phosphonate |
| 85.2% | Water |
| 0.4% | Polymer A |
| pH (1 g/l) | 5.0 |
| Viscosity | 250 mPas |

Formulation for rinse aid gel for automatic dishwashing

| 14.0% | Genapol 2909 |
|---|---|
| 3.0% | Citric acid |
| 5.0% | Cumenesulfonate |
| 77.5% | Water |
| 0.5% | Polymer C |
| pH (1 g/l) | 2.8 |
| Viscosity | 2000 mPas |

Formulation for machine dishwashing detergent gel

| 1.0% | Genapol 2544 |
|---|---|
| 2.1% | Soda |
| 32.9% | Citrate/citric acid |
| 0.3% | Monopropylene glycol |
| 0.5% | Polymer A |
| 63.2% | Water |
| pH (1 g/l) | 5.9 |
| Viscosity | 7 mPas |

Formulation for acidic bath cleaners

| | |
|---|---|
| 1.7% | Hostapur SAS 60 |
| 4.0% | Genapol UD 080 |
| 2.0% | Sokalan CP 45 |
| 0.5% | Propylene glycol monobutyl ether |
| 0.3% | Lactic acid |
| 2% | Polymer A |
| 89.6% | Water |
| pH (1 g/l) | 3.3 |
| Viscosity | 500 mPas |
| 4.4% | Lauryl sulfate |
| 1.4% | Soap |
| 3.9% | Genaminox LA |
| 9.8% | Citrate/citric acid |
| 3.3% | Propylene glycol monobutyl ether |
| 0.45% | Polymer C |
| 76.75% | Water |
| pH (1 g/l) | 3.7 |
| Viscosity | <3000 mPas |
| 2.3% | Sandosan LNBA |
| 2.5% | Genapol UD 080 |
| 2.0% | Propylene glycol monobutyl ether |
| 2% | Polymer B |
| 91.2% | Water |
| pH (1 g/l) | 3.3 |
| Viscosity | >2000 mPas |

Formulation of acidic cleaner (clear)

| | |
|---|---|
| 6.5% | Hostapur SAS 60 |
| 1.8% | Genapol LA 070 |
| 18.0% | Citric acid |
| 2.4% | Sodium chloride |
| 1% | Polymer A |
| 71.3% | Water |
| pH (1 g/l) | 2.0 |
| Viscosity | >2000 mPas |

This formulation would have to be thickened further. An advantage would be the impression of a higher activity and longer contact time/slower run-off time on vertical surfaces.

Fields of use for liquid cleaner gels with pH values of <5 which may be listed are, by way of example, floor and tile cleaning, bath tub and fittings cleaning and toilet cleaning.

1. A liquid washing, cleaning, disinfecting or bleaching composition comprising amphiphilic copolymers which include structural units derived from
a) acryloyldimethyltauric acid in free form, partially neutralized form or completely neutralized form with monovalent or divalent inorganic or organic cations, and
b) at least one hydrophobic comonomer based on ethylenically unsaturated polyalkylene alkoxylates, and optionally
c) further at least monovinylically unsaturated comonomers different from a) and b).

2. The liquid washing, cleaning, disinfecting or bleaching composition as claimed in claim 1, in which the copolymers have a molecular weight M_{w} of from 10³ g/mol to 10⁹ g/mol.

3. The liquid washing, cleaning, disinfecting or bleaching composition as claimed in claim 1 and/or 2, in which the acryloyldimethyltaurates (structural unit a) are Li⁺, Na⁺, K⁺, Mg⁺⁺, Ca⁺⁺, Al⁺⁺⁺, NH₄⁺, monoalkylammonium, dialkylammonium, trialkylammonium and/or tetraalkylammonium salts, where the alkyl substituents of the amines are, independently of one another, (C₁-C₂₂)-alkyl radicals, which may optionally be occupied by up to 3 (C₂-C₁₀)-hydroxyalkyl groups.

4. The liquid washing, cleaning, disinfecting or bleaching composition as claimed in one or more of claims 1 to 3, in which, based on the total mass of the copolymers, the content of acryloyldimethyltauric acid or acryloyidimethyltaurates is 0.1 to 99.9% by weight.

5. The liquid washing, cleaning, disinfecting or bleaching composition as claimed in one or more of claims 1 to 4, in which the macromonomers b) used are compounds according to formula (I)
R¹—Y-[(A)ᵥ-(B)_{w}—(C)ₓ-(D)_{z}]-R² (I)
in which
R¹ is a function capable of polymerization from the group of vinylically unsaturated compounds which is suitable for building up polymeric structures in a free-radical manner,
R² is a linear or branched aliphatic, olefinic, cycloaliphatic, arylaliphatic or aromatic (C₁-C₅₀)-hydrocarbon radical, OH, —NH₂, —N(CH₃)₂ or is the structural unit [—Y—R¹],
Y is —O—, —C(O)—, —C(O)—O—, —S—, —O—CH₂—CH(O—)—CH₂OH, —O—CH₂—CH(OH)—CH₂O—, —O—SO₂—O—, —O—SO—O—, —PH—, —P(CH₃)—, —PO₃—, —NH— and —N(CH₃)—,
A, B, C and D are derived from acrylamide, methacrylamide, ethylene oxide, propylene oxide, AMPS, acrylic acid, methacrylic acid, methyl methacrylate, acrylonitrile, maleic acid, vinyl acetate, styrene, 1,3-butadiene, isoprene, isobutene, diethylacrylamide and diisopropylacrylamide,
v, w, x and z, independently of one another are 0 to 500, where the sum of the four coefficients must on average be ≧1.

6. The liquid washing, cleaning, disinfecting or bleaching composition as claimed in one or more of claims 1 to 5, in which the molecular weight of the macromonomers b) is 200 g/mol to 10⁶ g/mol.

7. The liquid washing, cleaning, disinfecting and bleaching composition as claimed in one or more of claims 1 to 6, in which the comonomers c) used are olefinically unsaturated monomers chosen from N-vinylformamide (VIFA), N-vinylmethylformamide, N-vinylmethylacetamide (VIMA) and N-vinylacetamide; cyclic N-vinylamides (N-vinyllactams) with a ring size from 3 to 9, preferably N-vinylpyrrolidone (NVP) and N-vinylcaprolactam; amides of acrylic acid and methacrylic acid, preferably acrylamide, methacrylamide, N,N-dimethylacrylamide, N,N-diethylacrylamide and N,N-diisopropylacrylamide; alkoxylated acrylamides and methacrylamides, preferably hydroxyethyl methacrylate, hydroxymethylmethacrylamide, hydroxyethylmethacrylamide, hydroxypropylmethacrylamide and succinic mono-[2-(methacryloyloxy)ethyl ester]; N,N-dimethylaminomethacrylate; diethylaminomethyl methacrylate; acryl- and methacrylamidoglycolic acid; 2- and 4-vinylpyridine; vinyl acetate; glycidyl methacrylate; styrene; acrylonitrile; stearyl acrylate; lauryl methacrylate.
